(19) United States
(12) Patent Application Publication
(10) Pub. No.: US 2018/0318617 A1
(43) Pub. Date: Nov. 8, 2018

(54) DAMPER ASSEMBLY WITH SHAPE MEMORY ALLOY

(71) Applicant: Johnson Controls Technology Company, Auburn Hills, MI (US)

(72) Inventors: Kirk P. Henderson, Oconomowoc, WI (US); John T. Pierson, Whitefish Bay, WI (US)

(73) Assignee: Johnson Controls Technology Company, Auburn Hills, MI (US)

(21) Appl. No.: 15/968,709

(22) Filed: May 1, 2018

Related U.S. Application Data
(60) Provisional application No. 62/500,290, filed on May 2, 2017.

(51) Int. Cl. A62C 2/14; F24F 13/14

(52) U.S. Cl. CPC A62C 2/14; F24F 13/1426

(57) ABSTRACT

A damper assembly includes one or more dampers configured to regulate air flow through the damper assembly and an actuator system configured to move the one or more dampers between an open position and a closed position. The actuator system includes a contraction component coupled to the one or more dampers and comprising a shape memory alloy material. The actuator system further includes a first connector attached to a first end of the contraction component and a second connector attached to a second end of the contraction component. The first connector and the second connector are electrically isolated from the one or more dampers. The contraction component is configured to contract in response to an electric current being applied to at least one of the first connector and the second connector, thereby moving the one or more dampers to the closed position.

### CROSS-REFERENCE TO RELATED PATENT APPLICATION

This application claims the benefit of and priority to U.S. Provisional Patent Application No. 62/500,290 filed May 2, 2017, the entire disclosure of which is incorporated by reference herein.

### BACKGROUND

Damper assemblies typically include a mechanical actuator system comprised of components such as gears and motors. These actuator systems can be configured to open and close a set of blade dampers in order to regulate air flow through the damper assembly, for example. The amount of parts included in these types of mechanical actuator systems can significantly increase the cost of the damper assembly.

### SUMMARY

One implementation of the present disclosure is a damper assembly. The damper assembly includes one or more dampers configured to regulate air flow through the damper assembly. The damper assembly further includes an actuator system configured to move the one or more dampers between an open position and a closed position. The actuator system includes a contraction component coupled to the one or more dampers and comprising a shape memory alloy material. The actuator system further includes a first connector attached to a first end of the contraction component and a second connector attached to a second end of the contraction component. The first connector and the second connector are electrically isolated from the one or more dampers. The contraction component is configured to contract in response to an electric current being applied to at least one of the first connector and the second connector, thereby moving the one or more dampers to the closed position.

In some embodiments, the damper assembly is a fire damper or a smoke damper within an HVAC system.

In some embodiments, the damper assembly further includes one or more sensors and a controller. The controller is configured to receive one or more readings from the one or more sensors and apply the electric current to at least one of the first connector and the second connector in response to the readings from the one or more sensors.

In some embodiments, the one or more sensors comprise at least one of a temperature sensor, an ultraviolet detector, or an infrared array.

In some embodiments, the damper assembly further includes a flame detector configured to detect smoke or fire and generate an output signal in response to detecting the smoke or the fire.

In some embodiments, the damper assembly further includes a controller configured to receive the output signal from the flame detector and apply the electric current based on the output signal from the flame detector.

In some embodiments, the contraction component is sensitive to temperature and configured to contract in response to an ambient temperature exceeding a threshold temperature.

In some embodiments, the threshold temperature is at least 220° F.

In some embodiments, the electric current has an amperage of at least 0.5 amperes.

In some embodiments, the contraction component is a spring, a rod, or a wire.

Another implementation of the present disclosure is a damper assembly. The damper assembly includes one or more dampers configured to regulate air flow through the damper assembly. The damper assembly further includes an actuator system configured to move the one or more dampers between an open position and a closed position. The actuator system includes a contraction component composed of a shape memory alloy material and coupled to the one or more dampers. The contraction component is configured to contract in response to an ambient temperature exceeding a threshold temperature, thereby moving the one or more dampers to the closed position.

In some embodiments, the damper assembly is a fire damper or a smoke damper within an HVAC system.

In some embodiments, the threshold temperature is at least 220° F.

In some embodiments, the damper assembly further includes a safety lock comprising a second contraction component comprising a shape memory alloy material.

In some embodiments, the second contraction component is configured to contract in response to the ambient temperature exceeding a second threshold temperature, thereby locking the one or more dampers in the closed position.

In some embodiments, the second threshold temperature is at least 250° F.

In some embodiments, the damper assembly further includes one or more sensors and a controller. The controller is configured to receive one or more readings from the one or more sensors and apply an electric current to the contraction component in response to the readings from the one or more sensors.

In some embodiments, the contraction component is configured to contract in response to the electric current being applied, thereby the one or more dampers to the closed position.

In some embodiments, the one or more sensors include a flame detector configured to detect smoke or fire and generate an output signal in response to detecting the smoke or the fire.

Another implementation of the present disclosure is method. The method includes operating one or more dampers of a damper assembly to regulate air flow through the damper assembly by moving the one or more dampers between an open position and a closed position. The method further includes applying at least one of heat or electric current to a contraction component of the damper assembly coupled to the one or more dampers and including a shape memory alloy material, the heat or electric current causing the contraction component to contract, thereby moving the one or more dampers to the closed position.

Those skilled in the art will appreciate that the summary is illustrative only and is not intended to be in any way limiting. Other aspects, inventive features, and advantages of the devices and/or processes described herein will become apparent in the detailed description set forth herein and taken in conjunction with the accompanying drawings.

### BRIEF DESCRIPTION OF THE DRAWINGS

FIG. 1 is a drawing of a building equipped with a HVAC system, according to some embodiments.

FIG. 2 is a block diagram of a waterside system that may be used in conjunction with the building of FIG. 1, according to some embodiments.

FIG. 3 is a block diagram of an airside system that may be used in conjunction with the building of FIG. 1, according to some embodiments.

FIG. 4 is a depiction of a fire damper system with shape memory alloy, according to some embodiments.

FIG. 5 is perspective view of the damper assembly and SMA actuator system of the fire damper system with shape memory alloy of FIG. 4, according to some embodiments.

FIG. 6 is a perspective view of the SMA actuator system and SMA lock assembly of the fire damper system with shape memory alloy of FIG. 4, and with the SMA lock assembly in an unlocked position, according to some embodiments.

FIG. 7 is a perspective view of the SMA lock assembly of the fire damper system with shape memory alloy of FIG. 4, and with the SMA lock assembly in an locked position, according to some embodiments.

FIG. 8 is a view of a SMA actuator device of the SMA lock assembly of the fire damper system with shape memory alloy of FIG. 4, according to some embodiments.

### DETAILED DESCRIPTION

### Overview

Referring generally to the FIGURES, a fire damper system with shape memory alloy (SMA) and components thereof are shown, according to various embodiments. The fire damper system with SMA can be implemented in a building with a building management system and/or an HVAC system.

Current damper systems involve a mechanical system of gears and motors, which can be expensive to implement and maintain. Embodiments of the present disclosure utilize SMA to replace parts of the mechanical system, such as a fusible link. An exemplary embodiment includes a SMA actuator system to open and close dampers in a damper system. The SMA actuator system can include a contraction spring that responds to heat such that SMA actuator system closes the dampers upon exceeding a threshold temperature. In addition, the SMA actuator system closes the dampers in response to an electric current. This design acts as a fail safe. The fire damper system with SMA can also include a SMA safety lock that activates at a second threshold temperature. In other embodiments, components of the fire damper system with SMA can be implemented in systems that may or may not be related to fire safety.

### Building Management System and HVAC System

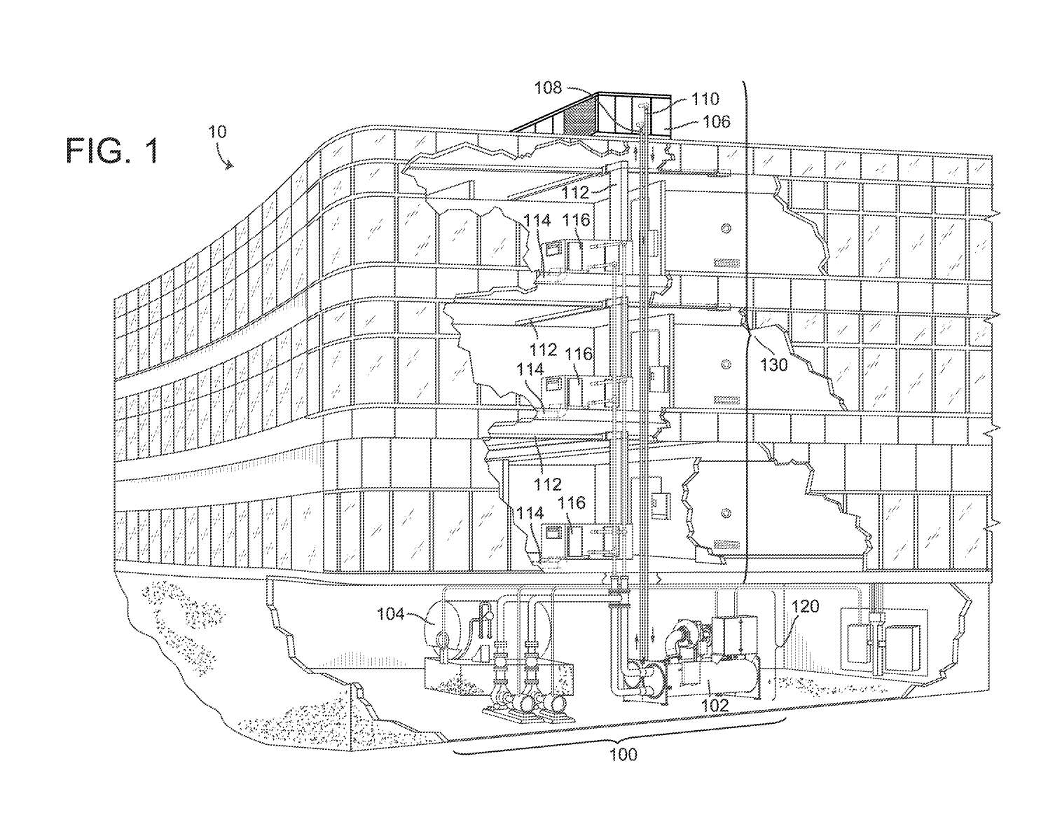

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

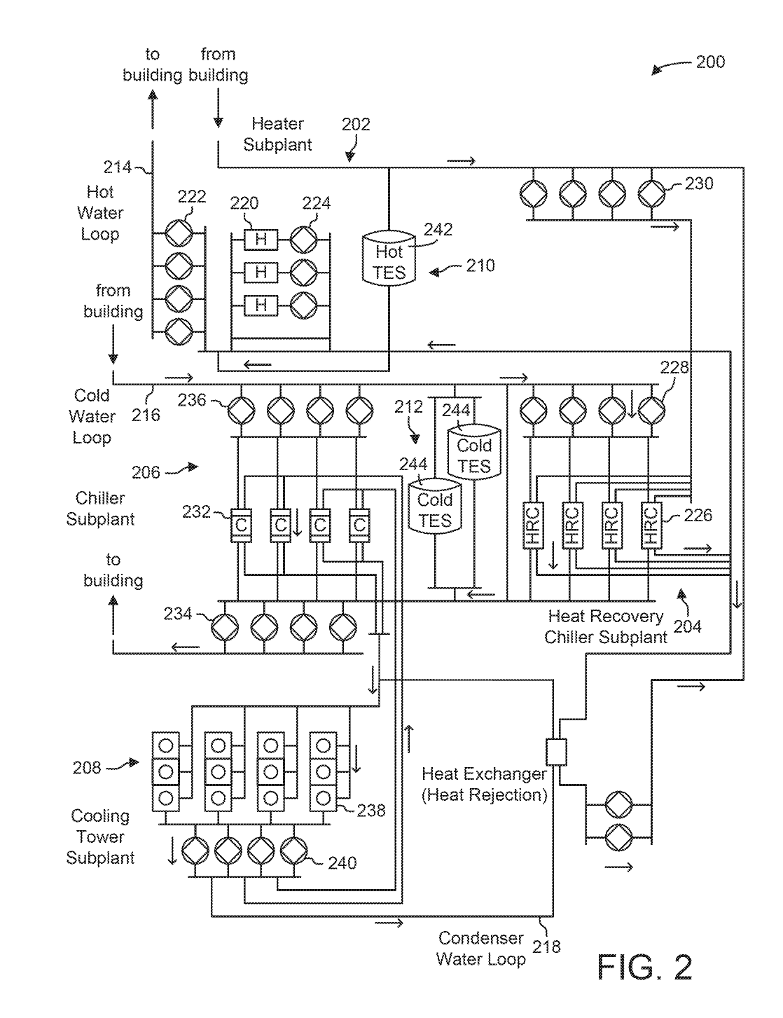

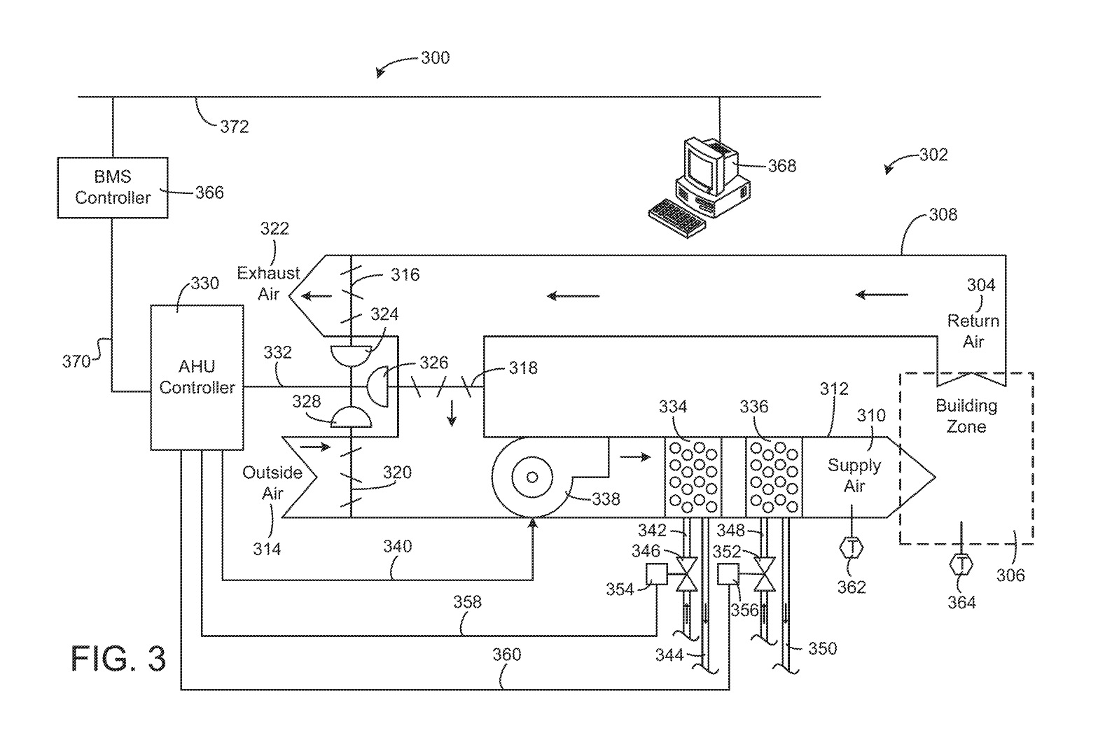

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 ands/or AHU controller 330 via communications link 372.

Fire Damper System with Shape Memory Alloy

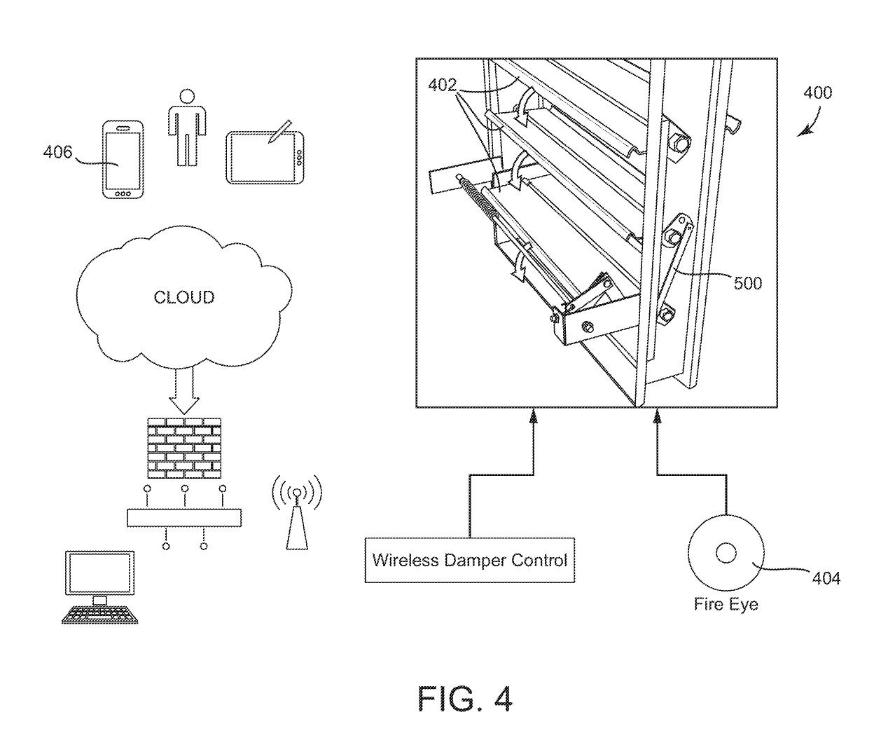

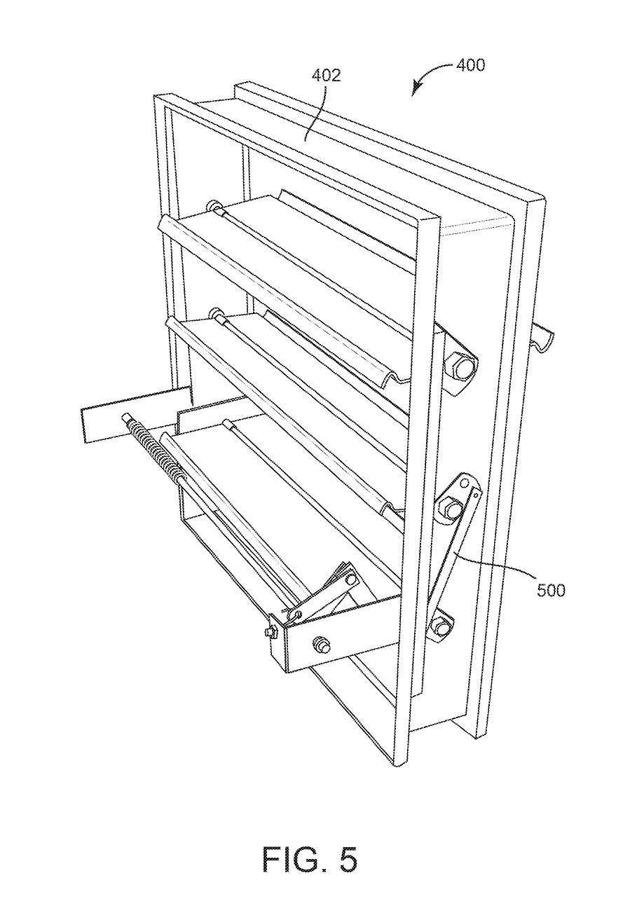

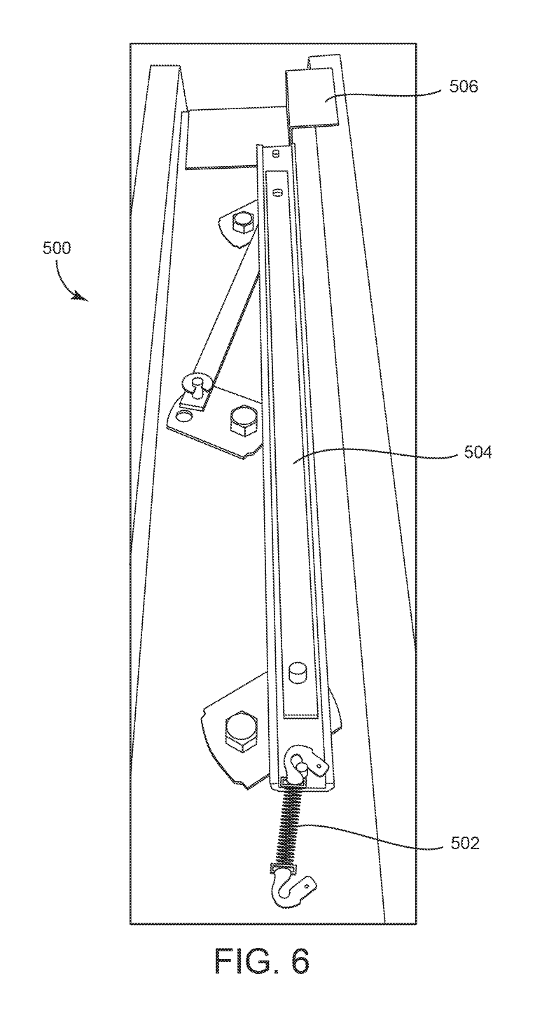

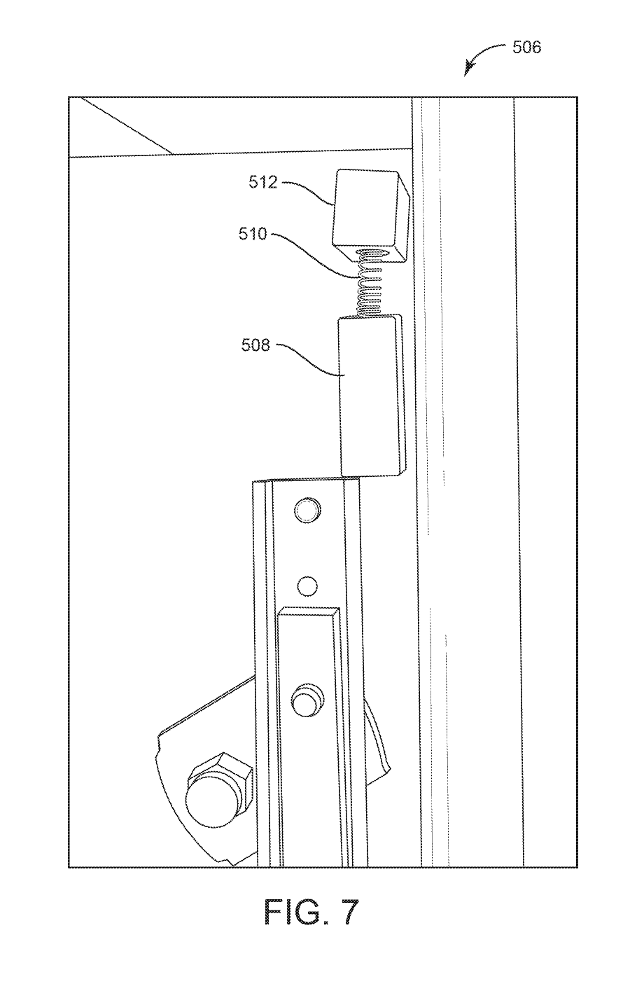

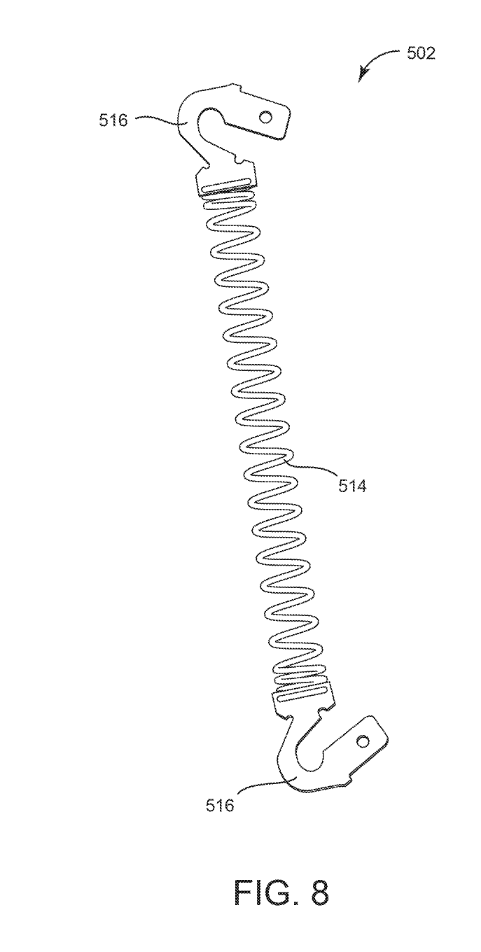

Referring now to FIGS. 4-9 a fire damper system 400 with shape memory alloy (SMA) is shown, according to various embodiments. Embodiments of the present disclosure employ SMA parts to replace one or more parts of a damper system, such as a fusible link used in a conventional systems. Referring to FIGS. 4-5, a diagram of a fire damper system 400 with SMA is depicted, according to some embodiments. System 400 is shown to include a damper assembly 402, a set of sensors 404, web-based interface 406, and a SMA actuator system 500.

In some embodiments, system 400 includes a set of sensors 404. Sensors 404 can be electrically and/or communicably connected to SMA actuator system 500, such that dampers of assembly 402 can open or close in response to input received from sensors 404. Sensors 404 can include any types of sensors such as a heat, fire, or smoke sensors. Sensors 404 can be configured to provide a sensor input (e.g., temperature or smoke measurements, operating statuses, diagnostics, etc.) to BMS controller 366. BMS controller 366 can be configured to subsequently actuate dampers of damper assembly 402 via SMA actuator system 500 in response to the sensor input.

Web-based interface 406 is generally configured to allow remote or web-based access to aspects of system 400 via an electronic network (e.g. the Internet). Aspects of system 400 can be visually adapted on a mobile device or any type of device capable of connecting to the network. For example, aspects of system 400 may include a damper position, an ambient temperature, etc. In this regard, web-based interface 406 can be communicably connected via the network to BMS controller 366 and thereby various other devices connected to BMS controller 366 (e.g., other sensors). In some embodiments, web-based interface 406 includes a 3D augmented view of a damper opening and closing and a user with suitable authorization is first authenticated via the mobile device.

Referring to FIGS. 5-9, SMA actuator system 500 is shown to include a SMA actuator 502, a crank mechanism 504, and a SMA lock 506. SMA actuator 502 is shown to include a contraction spring 514 and a set of connectors 516. A first end of SMA actuator 502 is shown to be attached to an arm of crank mechanism 504 using a connector 516. A second end of SMA actuator 502 is configured to be attached to the frame of damper assembly 402 (not shown). For example, SMA actuator 502 can be attached to an immovable post of the frame. In this regard, the second end of SMA actuator 502 is configured to remain static, while the first end of SMA actuator 502 may dimensionally contract and/or expand in response to temperature and/or electric current applied to SMA actuator 502.

SMA lock 506 can be a safety lock and is shown to include an expansion spring 510. A first end of expansion spring is attached to a cog 508. A second end of expansion spring 510 is attached to an immovable post 512. In this regard, the second end of SMA lock 506 is configured to remain static, while the first end of SMA lock 506 may dimensionally contract and/or expand in response to temperature and/or electric current. For example, cog 508 attached to the first end of expansion spring 510 can be configured to dimensionally travel to a position between the arm of crank mechanism 504 and a wall of frame, such that crank mechanism 504 is locked in a position corresponding to a closed blade position. In some embodiments, SMA lock 506 can additionally include a protective cover that shields portions of expansion spring 510, immovable post 512, and/or cog 508.

In an example embodiment, contraction spring 514 is configured to dimensionally contract when exposed to a first threshold temperature and/or a first electric current, and expansion spring 510 is configured to dimensionally expand when exposed to a second threshold temperature and/or a second electric current. Contraction spring 514 and expansion spring 510 contract and expand, respectively, due to their chemical composition as a shape memory alloy. As used herein, the terminology “shape memory alloy” (often abbreviated as “SMA”) refers to alloys which exhibit a shape memory effect. A SMA may undergo a solid state, crystallographic phase change to shift between a martensite phase, i.e., “martensite”, and an austenite phase, i.e., “austenite.” Alternatively stated, an SMA may undergo a displacive transformation rather than a diffusional transformation to shift between martensite and austenite. A displacive transformation is a structural change that occurs by the coordinated movement of atoms (or groups of atoms) relative to their neighbors.

Contraction spring 514 and expansion spring 510 may use any suitable SMA composition. In an example embodiment, contraction spring 514 and expansion spring 510 use a combination of nickel and titanium with a small additive of aluminum. Contraction spring 514 and expansion spring 510 may include an element selected from the group including, without limitation: cobalt, nickel, titanium, indium, manganese, iron, palladium, zinc, copper, silver, gold, cadmium, tin, silicon, platinum, gallium, and combinations thereof. For example, and without limitation, suitable shape memory alloys may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations thereof. SMA actuator 502 and SMA lock 506 may have components with binary, ternary, or any higher order so long as the shape memory alloy material exhibits a shape memory effect (i.e., a change in shape orientation, damping capacity, etc.). The specific shape memory alloy material may be selected according to desired operating temperatures of contraction spring 514 and an expansion spring 510.

When system 400 is in a normal operating state, damper blades of assembly 402 are in an open position due to an opposing spring (e.g. steel) holding the damper blades open. In embodiments, damper assembly 402 can be generally configured as described above (e.g. airside system 300). Damper assembly 402 includes a plurality of damper blades rotatably coupled to a frame that retains the blades within a building duct. In an open configuration, damper blades of assembly 402 may be substantially parallel to the direction of air flowing through the building duct. Damper blades can be configured to rotate from an open position to a closed blade position. In embodiments, SMA actuator system 500 is coupled to damper blades of assembly 402 such that the damper blades rotate from a substantially horizontal position when the damper blades are opened to a substantially vertical position when the damper blades are closed.

In some embodiments, damper blades of damper assembly 402 remain open due to a mechanical system that includes crank mechanism 504, a spring mechanism, a rotatable U-joint and securing hardware (e.g. one or more bolts, pins, nuts, and washers). In this regard, spring mechanism may act to oppose movement of the rotatable U-Joint such that the damper blades remain in an open position until a sufficiently greater force acts against the spring mechanism. In particular, damper blades close when an arm of crank mechanism 504 dimensionally moves in a direction corresponding to the closed damper position.

In embodiments, SMA actuator 502, a crank mechanism 504, and a SMA lock 506 act in concert to actuate damper blades of damper assembly 402 to a closed, locked position in response to heat and/or electric current. In a normal operating state, contraction spring 514 and an expansion spring 510 are exposed to a normal ambient temperature representing normal operating conditions (e.g. 60° F.-80° F.). In particular, at normal ambient temperatures, contraction spring 514 is in an expanded position, and expansion spring 510 is in a contracted position.

Contraction spring 514 of SMA actuator 502 is configured to contract from an expanded position when exposed to a first temperature threshold and/or a first electric current. In embodiments, the first temperature threshold can be 250° F. Because the second end of contraction spring 514 is attached to an immovable post, the first end (attached to crank mechanism 504) is forced to dimensionally travel in a contracting direction upon the contraction spring being exposed to the first temperature threshold and/or first electric current threshold. In this regard, contraction spring 514 supplies a sufficient force to act against the spring mechanism of damper assembly 402, thereby actuating damper blades of damper assembly 402 to a closed position by moving. The ability of SMA actuator 502 to respond to both heat and electric current provides a significant advantage. For example, system 500 may typically respond to electric current, but the ability to also respond to heat provides a fail-safe mechanism. The presence of a fire will heat contraction spring 514, thereby causing it to contract and close the damper blades.

Expansion spring 510 of SMA lock 506 is configured to expand when exposed to a second temperature threshold and/or a second electric current. The second temperature threshold generally corresponds to a temperature that permits SMA lock 506 to adequately lock damper assembly 402 in a closed position. In embodiments the second temperature threshold can be equal to or greater than the first temperature threshold, such as 300° F. Because the second end of expansion spring 510 is attached to an immovable post 512, the first end (attached to cog 508) is forced to dimensionally travel in an expanding position upon the expansion spring 510 being exposed to the second temperature threshold and/or second electric current. In particular, cog 508 attached to the first end of expansion spring 510 can be configured to dimensionally travel to a position between the arm of crank mechanism 504 and a wall of frame, such that crank mechanism 504 is locked in a position corresponding to a closed blade position.

In other embodiments, SMA actuator system 500 can additionally or alternatively include a rod or wire of SMA composition to perform one or more functions of SMA actuator system 500. For example, in some embodiments, a SMA wire can be configured in SMA actuator system 500 to replace SMA actuator 502. In some embodiments, SMA actuator 502 and/or SMA lock 506 may include a SMA spring responsive to electricity. In this regard, a controller or microprocessor can be electrically connected to SMA actuator 502 and/or SMA lock 506 such that SMA actuator 502 and/or SMA lock 506 can be selectively actuated by the microprocessor. An electrical implementation may be desirable to allow SMA actuator system 500 to be tested. For example, an electric current can be applied to SMA actuator 502 to cause SMA actuator 502 to open/close the damper blades in response to a signal from a controller or user device. The status of the test (e.g., the position of the damper blades, the status of SMA lock 506, etc.) can be viewed on an electronic display of the user device to enable remote monitoring and testing of SMA actuator system 500.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A damper assembly comprising:
one or more dampers configured to regulate air flow through the damper assembly; and
an actuator system configured to move the one or more dampers between an open position and a closed position, the actuator system comprising:
a contraction component coupled to the one or more dampers and comprising a shape memory alloy material;
a first connector attached to a first end of the contraction component and electrically isolated from the one or more dampers; and
a second connector attached to a second end of the contraction component and electrically isolated from the one or more dampers;
wherein the contraction component is configured to contract in response to an electric current being applied to at least one of the first connector and the second connector, thereby moving the one or more dampers to the closed position.

2. The damper assembly of claim 1, wherein the damper assembly is a fire damper or a smoke damper within an HVAC system.

3. The damper assembly of claim 1, further comprising:
one or more sensors; and
a controller configured to receive one or more readings from the one or more sensors and apply the electric current to at least one of the first connector and the second connector in response to the readings from the one or more sensors.

4. The damper assembly of claim 3, wherein the one or more sensors comprise at least one of a temperature sensor, an ultraviolet detector, or an infrared array.

5. The damper assembly of claim 1, further comprising a flame detector configured to detect smoke or fire and generate an output signal in response to detecting the smoke or the fire.

6. The damper assembly of claim 5, further comprising a controller configured to receive the output signal from the flame detector and apply the electric current based on the output signal from the flame detector.

7. The damper assembly of claim 1, wherein the contraction component is sensitive to temperature and configured to contract in response to an ambient temperature exceeding a threshold temperature.

8. The damper assembly of claim 7, wherein the threshold temperature is at least 220° F.

9. The damper assembly of claim 1, wherein the electric current has an amperage of at least 0.5 amperes.

10. The damper assembly of claim 1, wherein the contraction component is a spring, a rod, or a wire.

11. A damper assembly comprising:
one or more dampers configured to regulate air flow through the damper assembly; and
an actuator system configured to move the one or more dampers between an open position and a closed position, wherein the actuator system includes a contraction component comprising a shape memory alloy material and coupled to the one or more dampers;
wherein the contraction component is configured to contract in response to an ambient temperature exceeding a threshold temperature, thereby moving the one or more dampers to the closed position.

12. The damper assembly of claim 11, wherein the damper assembly is a fire damper or a smoke damper within an HVAC system.

13. The damper assembly of claim 11, wherein the threshold temperature is at least 220° F.

14. The damper assembly of claim 11, further comprising a safety lock comprising a second contraction component comprising a shape memory alloy material.

15. The damper assembly of claim 14, wherein the second contraction component is configured to contract in response to the ambient temperature exceeding a second threshold temperature, thereby locking the one or more dampers in the closed position.

16. The damper assembly of claim 15, wherein the second threshold temperature is at least 250° F.

17. The damper assembly of claim 11, further comprising:
one or more sensors; and
a controller configured to receive one or more readings from the one or more sensors and apply an electric current to the contraction component in response to the readings from the one or more sensors.

18. The damper assembly of claim 17, wherein the contraction component is configured to contract in response to the electric current being applied, thereby the one or more dampers to the closed position.

19. The damper assembly of claim 17, wherein the one or more sensors comprise a flame detector configured to detect smoke or fire and generate an output signal in response to detecting the smoke or the fire.

20. A method comprising:
operating one or more dampers of a damper assembly to regulate air flow through the damper assembly by moving the one or more dampers between an open position and a closed position;
applying at least one of heat or electric current to a contraction component of the damper assembly coupled to the one or more dampers and comprising a shape memory alloy material, the heat or electric current causing the contraction component to contract, thereby moving the one or more dampers to the closed position.
